(19) United States
(12) Patent Application Publication
(10) Pub. No.: US 2025/0298643 A1
(43) Pub. Date: Sep. 25, 2025

(54) SYSTEM, METHOD, AND NON-TRANSITORY COMPUTER READABLE MEDIUM

(71) Applicant: FUJIFILM Business Innovation Corp., Tokyo (JP)

(72) Inventor: Masaharu TONOUCHI, Kanagawa (JP)

(73) Assignee: FUJIFILM Business Innovation Corp., Tokyo (JP)

(21) Appl. No.: 18/771,682

(22) Filed: Jul. 12, 2024

(30) Foreign Application Priority Data
Mar. 22, 2024 (JP) 2024-047316

(51) Int. Cl. G06F 9/451

(52) U.S. Cl. CPC G06F 9/453

(57) ABSTRACT

A system includes a processor configured to display, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

### CROSS-REFERENCE TO RELATED APPLICATIONS

This application is based on and claims priority under 35 USC 119 from Japanese Patent Application No. 2024-047316 filed Mar. 22, 2024.

### BACKGROUND

### (i) Technical Field

The present disclosure relates to a system, a method, and a non-transitory computer readable medium.

### (ii) Related Art

Japanese Unexamined Patent Application Publication No. 2014-215800 discloses an information processing device including: analyzing means for analyzing a job ticket to be imported and determining whether or not print settings of the job ticket are within the scope of the effective print functions provided by a printer to which the job ticket is to be printed; notifying means for giving notice of information pertaining to print settings other than the effective print functions, on the basis of the result of the analysis; receiving means for receiving a method of handling the print settings other than the effective print functions in response to the notification from the notifying means; and combining means for combining the print settings other than the effective print functions received by the receiving means with the print settings of the effective print functions to generate combined print settings.

Japanese Unexamined Patent Application Publication No. 2018-156171 discloses a control program for setting process settings information to be transmitted to an image-forming output control device that controls the execution of image-forming output according to the process settings information, the process settings information including information for setting process details for executing the image-forming output on the basis of instruction information received from a process execution control device that controls the execution of multiple processes. The control program causes the image-forming output control device to execute a process including: a unique process information generation step of generating the process settings information, including unique process information indicating process details unique to the image-forming output control device; and a control step of transmitting the process settings information to the process execution control device. The control program causes the process execution control device to execute a process including: a unique process information extraction step of extracting the unique process information from the process settings information; a display control step of displaying a settings screen for setting process setting values of the extracted unique process information; and a process setting value application step of applying the set process setting values to instruction information to be transmitted to the image-forming output control device to execute the image-forming output.

### SUMMARY

There are systems that enable a user to direct a series of printing-related processes using a print instruction document (also referred to as a job ticket).

The print instruction document is created in a prescribed description language, and therefore the user uses the prescribed description language to describe attribute values of print items corresponding to the details of printing the user wants performed.

In the past, the user would generate a print instruction document by selecting an attribute value of a print item and causing the print instruction document reflecting the details of the selected attribute value to be outputted to a printing system. In this case, the operation for generating the print instruction document needs to be performed every time an attribute value of a print item is selected.

Aspects of non-limiting embodiments of the present disclosure relate to helping the user to generate a print instruction document more easily than the case in which the user performs the operation for generating the print instruction document causing an operation corresponding to a user-specified attribute value of an item.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a system including a processor configured to display, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

### BRIEF DESCRIPTION OF THE DRAWINGS

An exemplary embodiment of the present disclosure will be described in detail based on the following figures, wherein:

FIG. 1 is a diagram illustrating an exemplary configuration of a printing system;

FIG. 2 is a diagram illustrating an exemplary functional configuration of a DFE;

FIG. 3 is a diagram illustrating an exemplary schematic configuration of an electrical system in a DFE;

FIG. 4 is a flowchart illustrating an example of the flow of a display process;

FIG. 5 is a diagram illustrating an example of a job template management screen;

FIG. 6 is a diagram illustrating an example of a job template editing screen;

FIG. 7 is a diagram illustrating an exemplary display of a description string corresponding to an attribute value indicating not to perform stapling;

FIG. 8 is a diagram illustrating an exemplary display of a description string corresponding to an attribute value indicating to perform stapling in the top left corner;

FIG. 9 is a diagram illustrating an example of a job ticket;

FIG. 10 is a diagram illustrating an example of an editing screen when a help display is off; and

FIG. 11 is a diagram illustrating an example of a description string corresponding to an attribute value represented by a combination of multiple types of attributes.

### DETAILED DESCRIPTION

Hereinafter, an exemplary embodiment of the disclosure will be described with reference to the drawings. Note that the same structural elements and the same processes are denoted with the same signs throughout all drawings, and duplicate description is omitted. Also, the dimension ratios in the drawings have been exaggerated for clarity, and may be different from the actual ratios in some cases.

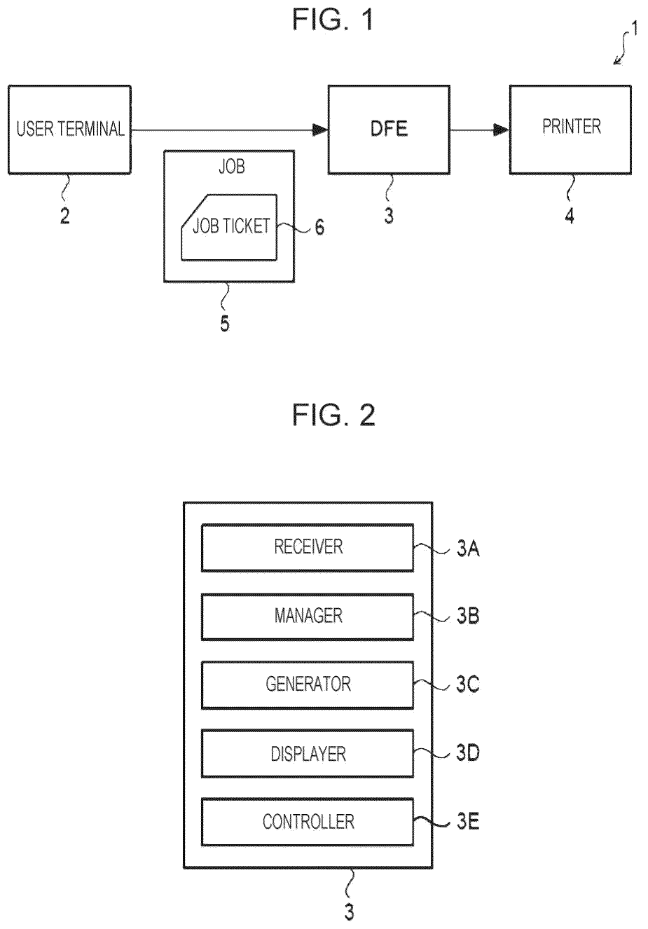

FIG. 1 is a diagram illustrating one example of a printing system 1 in which a workflow is utilized to perform printing on the basis of a job 5 designated by a user.

The printing system 1 includes, for example, a user terminal 2, a digital front end (DFE) 3, and a printer 4.

A workflow represents a flow of processes in which information to be used in each step is digitized according to the flow of printing steps, and the information is made available for use by a computer. In the printing system 1, a workflow is used to share information about each step and manage the status of each printing step.

The job 5 is a unit of execution to perform printing in the printing system 1, and includes data on printed material (referred to as “print data”) to be printed, in addition to attribute values of various attributes (referred to as “print attributes”) that define printing-related operations (referred to as “print operations”) for obtaining printed material in a user-desired state.

That is, for each job 5 managed on the basis of a workflow, the printing system 1 follows the print attributes designated by the job 5 to print the print data included in the job 5 onto a designated recording medium such as paper.

The user terminal 2 generates the job 5 of printed material in accordance with user instructions, and transmits the generated job 5 to the DFE 3. The job 5 is generated by workflow software preinstalled in the user terminal 2, for example. The workflow software is software that supports printed material workflows in the printing system 1. Since workflows differ depending on the type, number, performance, and the like of the devices forming the printing system 1, in some cases the workflow software is also individually tailored to the printing system 1 to be used.

The DFE 3 is notified of the attribute values of print attributes for printed material by a print instruction document (referred to as a “job ticket 6”). The job ticket 6 is an instruction document for causing the DFE 3 to execute user-desired printing operations according to a workflow, and the job ticket 6 is described using a predetermined description language interpretable in the DFE 3. A job ticket 6 is generated for each job 5 and transmitted to the DFE 3 along with print data and the like as information constituting the job 5.

Consequently, the workflow software that runs on the user terminal 2 provides a function for editing the job ticket 6 to the user. There are multiple types of description languages of the job ticket 6, but the present disclosure describes the example of using a description language in Job Definition Format (JDF), which is widely used as an industry-standard format in the printing industry. The description language of the job ticket 6 is not limited to JDF format, and another description language may be used.

The user uses the function for editing the job ticket 6 in the workflow software on the user terminal 2 to describe, in the job ticket 6, a string (referred to as a “description string”) representing an attribute value of a print attribute corresponding to a user-desired print operation, so that the user-desired print operation will be performed in the DFE 3.

The DFE 3 accepts the job 5 from the user terminal 2 and performs data processing on the print data included in the job 5 such that the print operation corresponding to the attribute value of the print attribute described in the job ticket 6 will be performed. Specifically, the DFE 3 interprets the content described in the job ticket 6 and generates a control command for achieving a print operation corresponding to the attribute value of the print attribute. Furthermore, the DFE 3 transmits the print data to the printer 4 and uses the generated control command to control the printer 4 such that the print operation designated by the job ticket 6 is performed on the print data. This DFE 3 is an example of a “system” according to the present disclosure.

The printer 4 prints the print data onto a recording medium according to accepted control commands and generates printed material based on the job ticket 6. Note that there are no restrictions on the printing method in the printer 4, which may be offset printing or on-demand printing, for example.

FIG. 2 is a diagram illustrating an exemplary functional configuration of the DFE 3. The DFE 3 includes the following functional units: a receiver 3A, a manager 3B, a generator 3C, a displayer 3D, and a controller 3E.

The receiver 3A receives the job 5 from the user terminal 2. In the example illustrated in FIG. 1, an example of receiving a job 5 from a single user terminal 2 is illustrated, but the receiver 3A may receive a job 5 from each of multiple user terminals 2.

The manager 3B manages job templates. A job template is a template for a job ticket 6 with predefined printing operations to be executed on print data.

For example, in the case of binding printed material using staples (referred to as “stapling”), if a job template designating the stapling position on the printed material is prepared in advance, the user is able to reuse the job template corresponding to stapling to generate the job ticket 6 to perform stapling at the designated position, without having the user themself generate the job ticket 6 every time. The manager 3B manages job templates corresponding to a variety of such printing operations.

Note that job template generation is performed by the user and registered in the DFE 3. If a job template has been registered in the DFE 3 and set to sharable, the user is able to freely use the job template, even if the job template was generated by another user.

The manager 3B also provides a job template editing function to the user, whereby a job template may be edited even after being registered in the DFE 3.

The generator 3C uses a job template selected by the user from among job templates registered in the DFE 3 to generate a job ticket 6 corresponding to the content of the job template. The job ticket 6 generated by the generator 3C is described in JDF format. The generator 3C outputs the generated job ticket 6 to a file, which enables the user to use the job ticket 6.

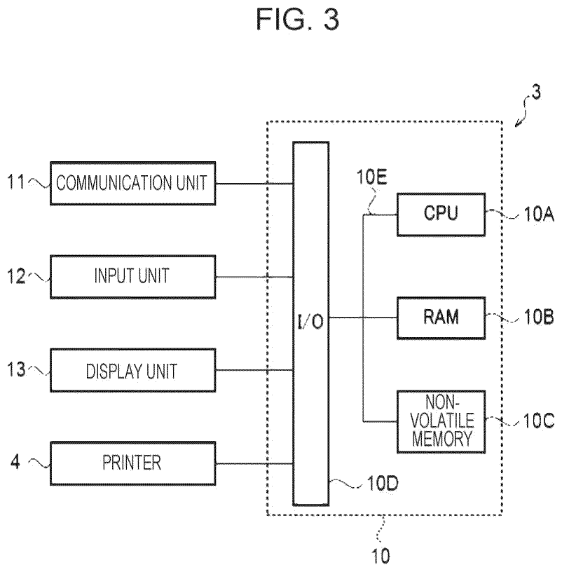

The displayer 3D displays the job ticket 6 generated by the generator 3C on a display unit 13 (see FIG. 3), for example, and additionally displays, on the display unit 13, a description string on the job ticket 6 that represents the attribute value of a print attribute corresponding to a user-desired print operation.

The description string on the job ticket 6 corresponding to an attribute value of a print attribute is displayed on the display unit 13 in the process of generating or editing a job template, but details will be described later.

The controller 3E controls the printer 4 such that printed material designated by the job ticket 6 is generated, and also carries out control for causing the receiver 3A, the manager 3B, the generator 3C, and the displayer 3D to perform the processes indicated above.

This DFE 3 is configured using a computer 10, for example. FIG. 3 is a diagram illustrating an exemplary schematic configuration of an electrical system in the DFE 3 configured using the computer 10.

The computer 10 is provided with a central processing unit (CPU) 10A, which is one example of a processor responsible for executing each functional unit of the DFE 3 illustrated in FIG. 2, random access memory (RAM) 10B used as a temporary work area of the CPU 10A, non-volatile memory 10C, and an input/output interface (I/O) 10D. The CPU 10A, RAM 10B, non-volatile memory 10C, and I/O 10D are interconnected through a bus 10E.

The non-volatile memory 10C is one example of a storage device that retains stored information even if electric power supplied to the non-volatile memory 10C is interrupted; semiconductor memory is used for example, but a hard disk may also be used. Information that, desirably, continues to be stored even after power supply to the DFE 3 is interrupted, such as job templates, for example, is stored in the nonvolatile memory 10C.

Note that the non-volatile memory 10C is not necessarily required to be built into the computer 10, and may also be a portable storage device that is removable from the computer 10, for example.

On the other hand, a communication unit 11, an input unit 12, a display unit 13, and the printer 4 are connected to the I/O 10D.

The communication unit 11 is connected to a communication channel (not illustrated) and is provided with a communication protocol use to transmit and receive data to and from an external device connected to the communication channel. The communication unit 11 is connected to the user terminal 2, for example.

The input unit 12 is a device that accepts user instructions and notifies the CPU 10A, and includes buttons, a touch panel, a mouse, a keyboard, and a pointing device, for example. In the computer 10 in the present disclosure, a mouse and keyboard are used as the input unit 12.

The display unit 13 is one example of a display device that displays information processed by the CPU 10A as an image, and includes a liquid crystal display (LCD) panel or an organic electroluminescence (EL) display, for example.

The printer 4 generates printed material by printing designated print data onto a designated recording medium according to designated printing operations, on the basis of instructions from the CPU 10A.

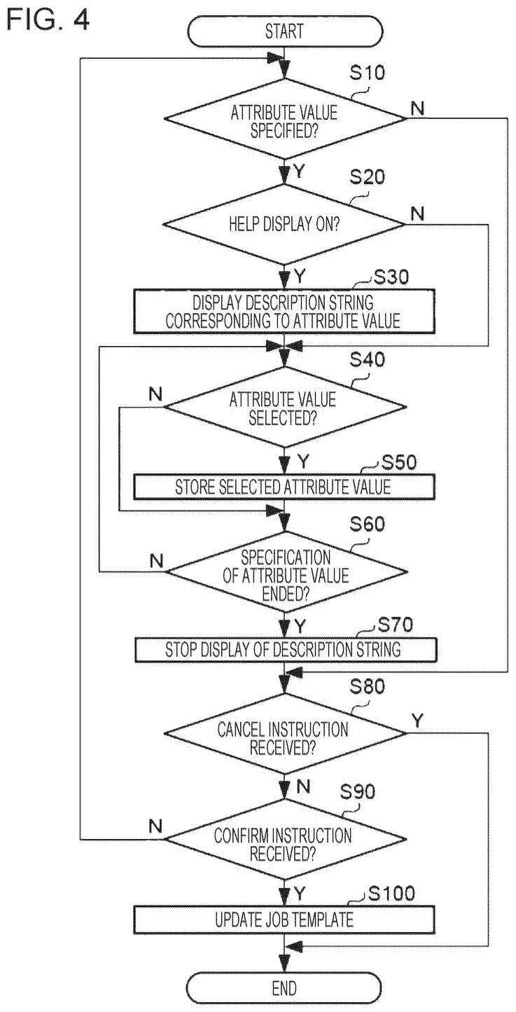

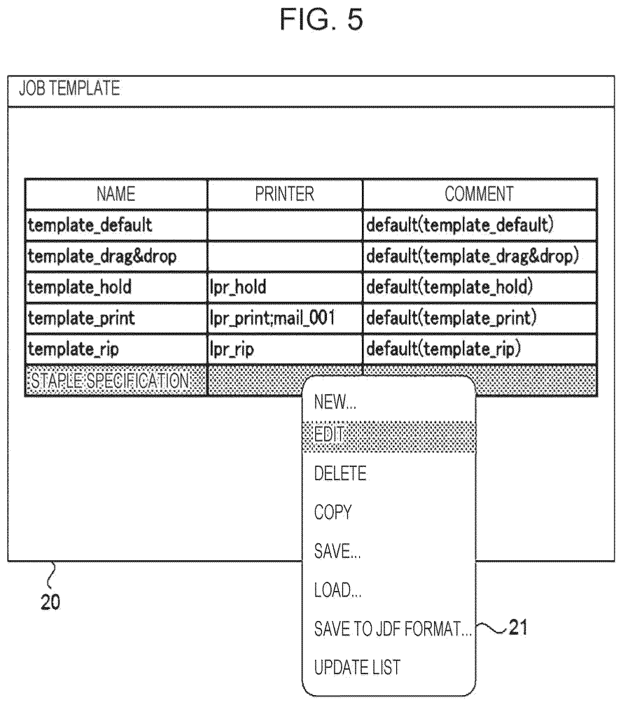

FIG. 4 is a flowchart illustrating one example of the flow of a display process executed by the CPU 10A of the DFE 3 in the case in which an editing screen 22 for editing a job template is displayed on the display unit 13.

A control program defining the display process is stored in advance in the non-volatile memory 10C of the DFE 3, for example. The CPU 10A of the DFE 3 loads the control program stored in the non-volatile memory 10C and executes the display process.

The editing screen 22 is displayed on the display unit 13 when, on the job template management screen 20 illustrated in FIG. 5, which is a screen for displaying a list of job templates managed by the DFE 3, “Edit” is selected from a menu 21 displayed by right-clicking the mouse on the display row of any of the job templates, for example. The job template management screen 20 illustrated in FIG. 5 represents an example in which the mouse is right-clicked on the display row of a job template defining staple printing operations, and “Edit” is selected from the menu 21.

Note that “selecting” in the present disclosure refers to performing a confirm operation on an object, which is an action indicative of an intent to execute an operation associated with the object. In the case of an operation using a mouse, “selecting” corresponds to an operation of left-clicking an object.

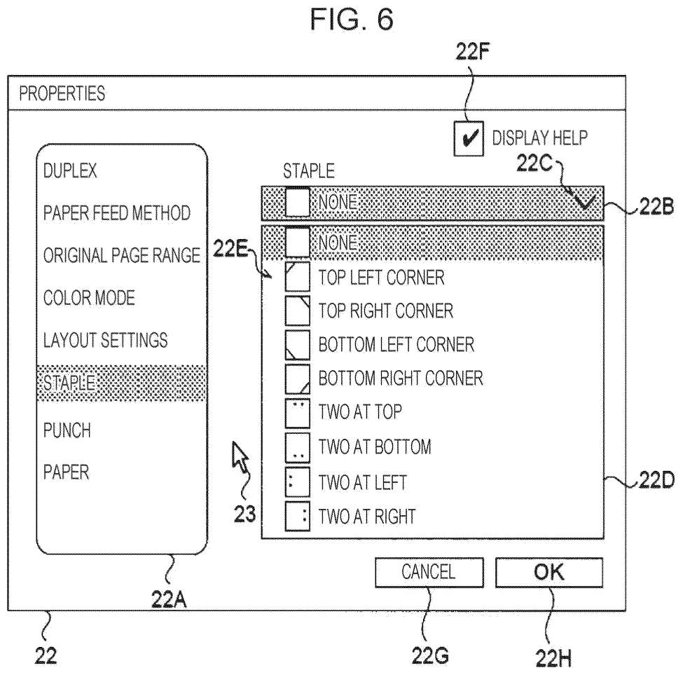

FIG. 6 is a diagram illustrating an example of the editing screen 22 of a job template defining staple printing operations. The following describes the display process for the case in which, in a situation where the editing screen 22 illustrated in FIG. 6 is being displayed on the display unit 13, the user gives an instruction by a mouse operation via the editing screen 22.

The editing screen 22 includes a display area 22A in which items representing print attributes are displayed. Each item displayed in the display area 22A is an example of an item defining an operation related to printing.

When any item is selected from the display area 22A in which the items are displayed, attribute values associated with the selected item are displayed in a display area 22B. In the case of changing the attribute value associated with the selected item, the user selects an expand mark 22C displayed in the display area 22B. When the expand mark 22C is selected, a list 22D of all attribute values that the selected item may take is displayed on the editing screen 22. Consequently, the user may select a desired attribute value to be set for the selected item from the list 22D, causing the selected attribute value to be associated with the selected item.

The example of the editing screen 22 illustrated in FIG. 6 represents a situation in which an item for setting the stapling position has been selected from the display area 22A, whereby the attribute value (“None” in the example in FIG. 6) set as the current stapling position is displayed in the display area 22B. In this situation, the expand mark 22C has been selected by the user, and all attribute values that could be set as the stapling position are displayed in the list 22D.

Meanwhile, for example, a cancel button 22G, an OK button 22H, and a checkbox 22F are displayed on the editing screen 22.

When the cancel button 22G on the editing screen 22 is selected, the CPU 10A is notified of a cancel instruction. Upon receiving the cancel instruction, the CPU 10A sets as the stapling position the attribute value that was originally set as the stapling position without change, even if the user had selected an attribute value different from the currently set attribute value from the list 22D, and closes the editing screen 22.

On the other hand, if the OK button 22H on the editing screen 22 is pressed, the CPU 10A is notified of a confirm instruction. Upon receiving the confirm instruction, the CPU 10A sets as the stapling position the attribute value that the user has selected from the list 22D, and closes the editing screen 22.

The checkbox 22F on the editing screen 22 is a selection object used by the user to select whether or not to display a description string corresponding to a specified attribute value when the user has specified any attribute value from among the attribute values displayed in the list 22D.

By putting a check into the checkbox 22F, the user instructs the CPU 10A to display the description string corresponding to the specified attribute value. Also, by not putting a check into the checkbox 22F, the user instructs the CPU 10A to not display the description string corresponding to the specified attribute value.

Hereinafter, putting a check into the checkbox 22F is referred to as “turning on the help display”, and not putting a check into the checkbox 22F is referred to as “turning off the help display”.

Also, an attribute value being “specified” means being in a state in which the attribute value may be selected. For example, selecting an attribute value from the list 22D with a mouse operation involves first moving a cursor 23 over a display row 22E in which the desired attribute value to select is displayed. This operation of moving the cursor 23 over the display row 22E in which an attribute value is displayed is referred to as “specifying an attribute value”. That is, a mouseover operation of hovering the cursor 23 over the display row 22E in which an attribute value is displayed corresponds to one example of an operation of specifying an attribute value. Note that in the case of using a touch panel as the input unit 12, for example, the specification and selection of an attribute value may be distinguished according to the length of time that a finger touches the area of the touch panel corresponding to the display position of the display row 22E.

In step S10 of the display process in FIG. 4, the CPU 10A determines whether or not any attribute value has been specified by the user from the list 22D on the editing screen 22.

If it is determined by the determination process in step S10 that any attribute value has been specified, the flow proceeds to step S20.

In step S20, the CPU 10A determines whether or not the help display is on. If the help display is on, the flow proceeds to step S30.

In step S30, the CPU 10A displays the description string corresponding to the specified attribute value on the editing screen 22, and then proceeds to step S40. In this case, the CPU 10A displays the description string according to JDF format, which allows the description string to be embedded directly into the job ticket 6.

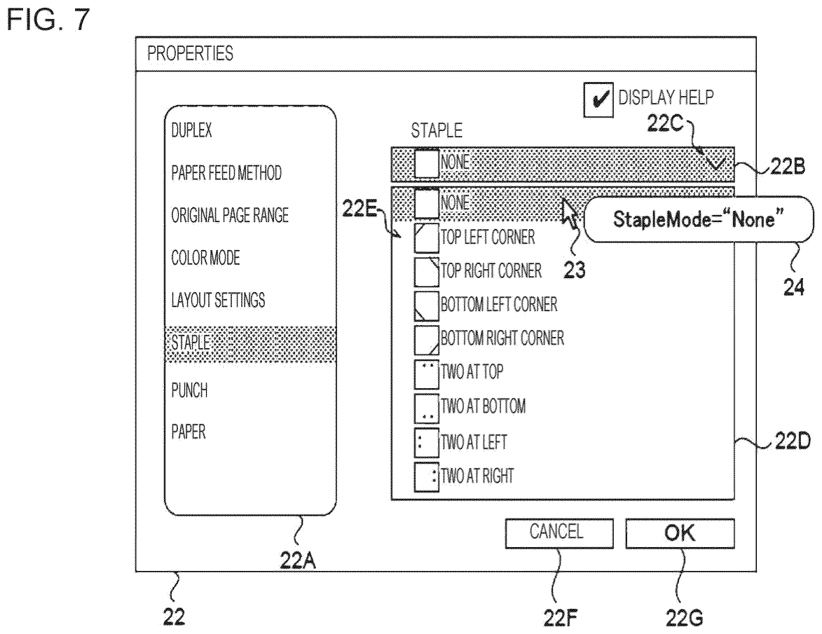

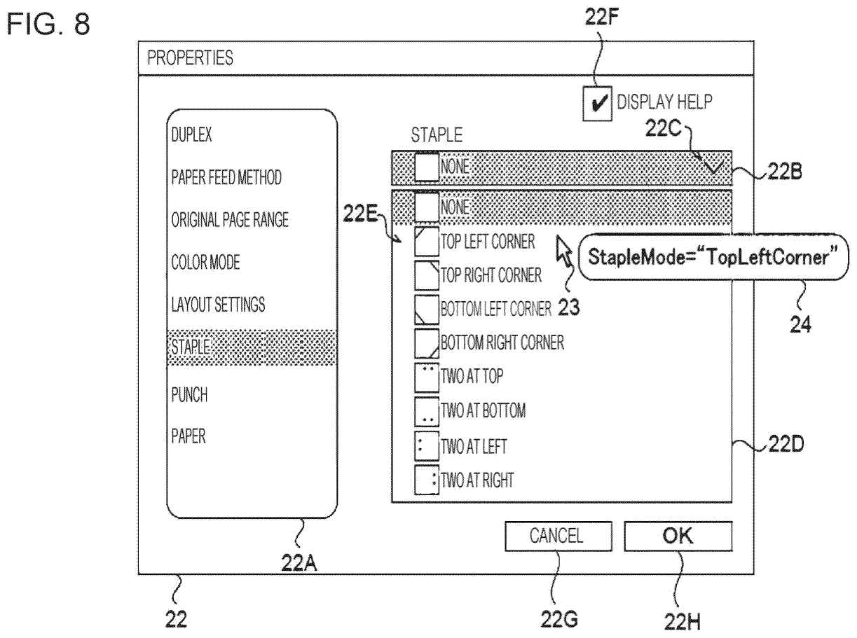

FIGS. 7 and 8 are each a diagram illustrating an exemplary display of a description string. Specifically, FIG. 7 is a diagram illustrating an exemplary display of a description string corresponding to an attribute value indicating not to perform stapling. In the example illustrated in FIG. 7, when the attribute value “None” is specified by the user, the description string ‘StapleMode=“None”’, which indicates not to perform stapling in the job ticket 6, is displayed in a popup window 24.

On the other hand, FIG. 8 is a diagram illustrating an exemplary display of a description string corresponding to an attribute value indicating to perform stapling in the top left corner. In the example illustrated in FIG. 8, when the attribute value “Top left corner” is specified by the user, the description string ‘StapleMode=“TopLeftCorner”’, which indicates to perform stapling at the top left corner in the job ticket 6, is displayed in the popup window 24.

Consequently, by simply specifying an attribute value, the user is able to understand what should be described in the job ticket 6 to cause the printer 4 perform the printing operation corresponding to the specified attribute value, without looking at a manual. Moreover, the description string displayed by the process in step S30 may be copied, which enables the user to generate the job ticket 6 by simply copying and pasting the displayed description string into a job ticket 6 that the user is creating, eliminating the need for the user to type in the description string with the keyboard.

Note that the display of the description string is not limited to a mode of display using the popup window 24, and any mode of display may be used insofar as the mode of display enables the user to recognize the description string. For example, the CPU 10A may also display a specified description string in a dedicated description string display area provided on the editing screen 22.

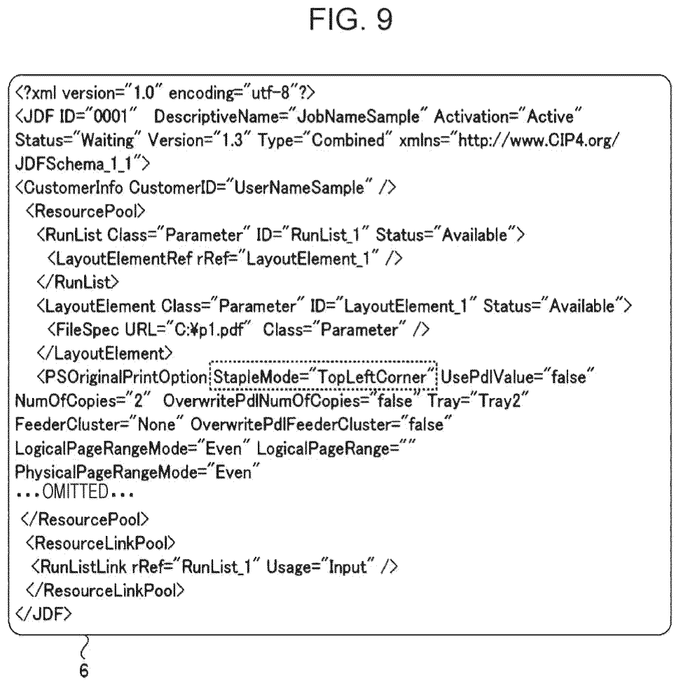

FIG. 9 is a diagram illustrating an example of a job ticket 6 in which the description string illustrated in FIG. 8 is described. In FIG. 9, the portion ‘StapleMode=“TopLeftCorner”’ enclosed in dashed lines corresponds to the description string displayed on the editing screen 22. Note that portions of the job ticket 6 other than the description string displayed on the editing screen 22 may be generated using a job template or be entirely described by the user, for example.

On the other hand, if it is determined by the determination process in step S20 that the help display is off, the flow proceeds to step S40 without executing the process in step S30. Consequently, when the help display is off, even if an attribute value is specified, the description string corresponding to the specified attribute value is not displayed on the editing screen 22.

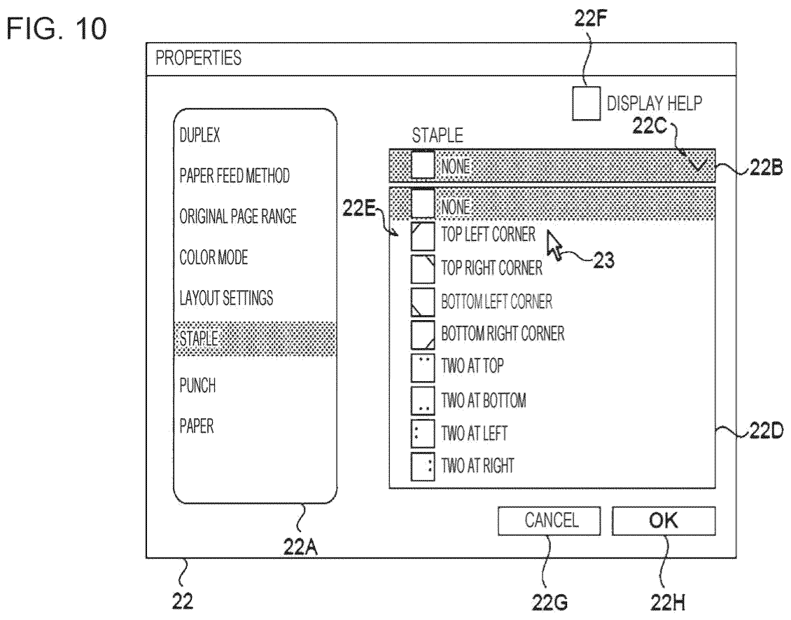

FIG. 10 is a diagram illustrating an example of the editing screen 22 when the help display is off. In the example illustrated in FIG. 10, when the attribute value “Top left corner” is specified by the user, the description string corresponding to the attribute value “Top left corner” as illustrated in FIG. 8 is not displayed.

If the user is a person who is thoroughly familiar with the editing of job tickets 6, for example, the display of the description string may not be necessary, as the user already knows the description string corresponding to the specified attribute value. Consequently, by turning off the help display, the display of the description string corresponding to a specified attribute value may be stopped.

In step S40 in FIG. 4, the CPU 10A determines whether or not any attribute value has been selected by the user from the list 22D on the editing screen 22. Upon determining that any attribute value has been selected, the flow proceeds to step S50.

In step S50, the CPU 10A displays the selected attribute value in the display area 22B on the editing screen 22 and stores the selected attribute value in the RAM 10B in association with the item selected in the display area 22A, and then proceeds to step S60.

On the other hand, if it is determined by the determination process in step S40 that no attribute value has been selected from the list 22D on the editing screen 22, the flow proceeds to step S60 without executing the process in step S50.

In step S60, the CPU 10A determines whether or not the cursor 23 has moved away from the display row 22E in which the currently specified attribute value is displayed and the specification of an attribute value has ended. If the specification of an attribute value has not ended, the flow proceeds to step S40, and the determination of whether or not an attribute value has been selected continues. If the specification of an attribute value has ended, the flow proceeds to step S70.

In step S70, since the specification of an attribute value has ended, the CPU 10A stops the display of the description string displayed by the process in step S30, and then proceeds to step S80. Note that if the help display is off, the process in step S30 is not executed and a description string is not displayed, and therefore there is no need to stop the display of the description string.

On the other hand, the flow also proceeds to step S80 when it is determined by the determination process in step S10 that no attribute value has been specified from the list 22D.

In step S80, the CPU 10A determines whether or not a cancel instruction has been received. If a cancel instruction has not been received, the flow proceeds to step S90.

In step S90, the CPU 10A determines whether or not a confirm instruction has been received. If a confirm instruction has not been received, the flow proceeds to step S10, and the process from step S10 to step S90 is executed repeatedly until a confirm instruction or a cancel instruction is received. If a confirm instruction has been received, the flow proceeds to step S100.

In step S100, the CPU 10A updates the job template by setting the attribute value stored in the RAM 10B by the process in step S50 as the attribute value of the item selected in the display area 22A. Since the editing of the job template has ended, the CPU 10A closes the editing screen 22 and ends the display process illustrated in FIG. 4.

On the other hand, if it is determined by the determination process in step S80 that a cancel instruction has been received, the CPU 10A closes the editing screen 22 and ends the display process illustrated in FIG. 4 without executing the determination process in step S90 or the process in step S100. That is, the job template is not updated if a cancel instruction has been received.

The user is able to cause the DFE 3 to perform a user-desired printing operation by describing, in the job ticket 6, the description string displayed in the popup window 24 as-is and transmitting the job ticket 6 together with the print data from the user terminal 2 to the DFE 3.

In this way, according to the DFE 3 according to an embodiment of the present disclosure, when any attribute value that an item defining an operation related to printing may take is specified by the user via the editing screen 22, a string corresponding to the specified attribute value is displayed on the editing screen 22, the string being a description string to be described in the job ticket 6 with which the user instructs the CPU 10A to perform the operation corresponding to the attribute value.

Note that, depending on the situation, it may be better for the CPU 10A to display the description string corresponding to an attribute value, even if the help display is set to off. For example, if the specified attribute value is specified by the user for the first time, the user often will not know the description string corresponding to the specified attribute value. Consequently, in such cases, it is preferable for the CPU 10A to display the description string corresponding to the specified attribute value on the editing screen 22, even if the help display is set to off.

This process is achieved by having the CPU 10A store a history of the specification of attribute values by the user in the non-volatile memory 10C on a per-user basis.

Also, FIGS. 7 and 8 each illustrate an exemplary display of the description string corresponding to an attribute value represented by the single attribute of the stapling position. Consequently, in whichever case, a description string is displayed in which a string representing the attribute value specified in that particular case is associated with the single attribute “StapleMode”.

However, the content of some attribute values may be represented by a combination of multiple types of attributes.

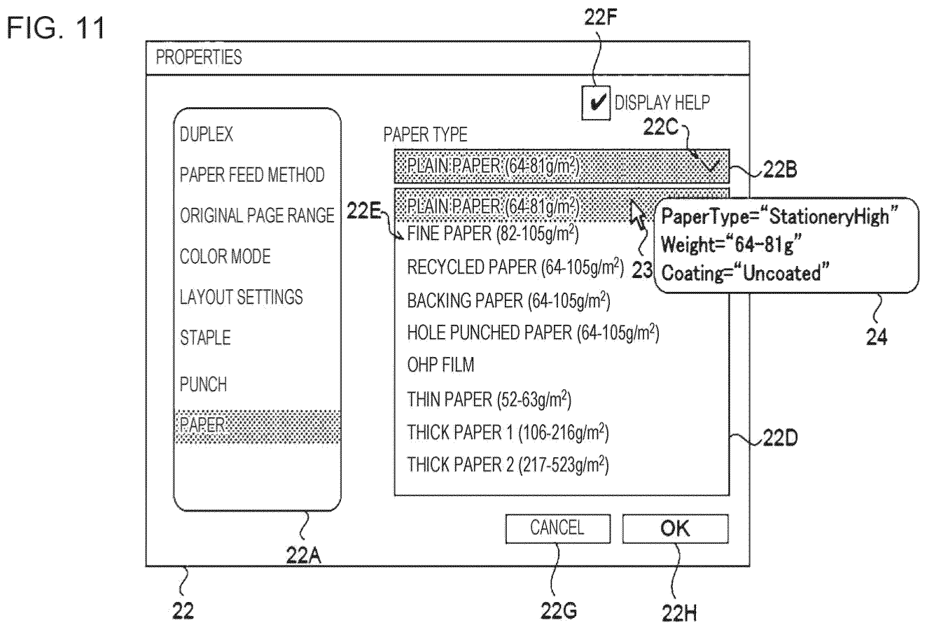

FIG. 11 is a diagram illustrating an example of a description string corresponding to an attribute value represented by a combination of multiple types of attributes.

There are various paper types on which print data may be printed, such as plain paper, fine paper, and recycled paper. For each of these various types of paper, even the same type of paper may be treated as different types of paper depending on, for example, differences in basis weight or the presence or absence of a coating on the surface of the paper.

As illustrated in FIG. 11, assume, for example, that the user has specified plain paper as the paper type on the editing screen 22. In this case, if plain paper is defined in the DFE 3 to be paper without a coating on the surface of the paper and with a basis weight equal to or greater than 64 g/m2 and less than or equal to 81 g/m2, plain paper is represented by combination of the three attributes of paper type, basis weight, and coating. Consequently, the CPU 10A displays the description string ‘PaperType=“StationeryHigh”, Weight=“64-81 g”, Coating=“Uncoated”.

Note that the paper type is represented as being plain paper by ‘PaperType=“StationeryHigh”’ and the basis weight is represented as being equal to or greater than 64 g/m2 and less than or equal to 81 g/m2 by ‘Weight=“64-81 g”’. Also, the absence of a coating on the surface of the paper is represented by ‘Coating=“Uncoated”’.

Also, the above describes an example in which the description string corresponding to an attribute value specified by the user is displayed on the job template editing screen 22, but a job template generating screen (not illustrated) for generating a new job template may also be displayed. That is, the CPU 10A displays the description string corresponding to an attribute value specified by the user on a screen on which the attribute values of print attributes corresponding to printing operations are displayed.

In this way, when a specified attribute value is represented by a combination of multiple types of attributes, the CPU 10A displays a description string for each attribute associated with the specified attribute value.

The above uses an exemplary embodiment to describe one aspect of the printing system 1, but the disclosed aspect of the printing system 1 is an example, and aspects of the printing system 1 are not limited to the scope described in the exemplary embodiment. Various modifications or alterations may be made to the exemplary embodiment within a scope that does not depart from the gist of the present disclosure, and any embodiments obtained by such modifications or alterations are also included in the technical scope of the present disclosure.

For example, the internal order of processes in the display process illustrated in FIG. 4 may be changed within a scope that does not depart from the gist of the present disclosure.

The exemplary embodiment above describes an aspect in which the display process is realized by software processing as an example. However, processing that is substantially the same as the flowchart of the display process may also be configured to be executed in hardware. In this case, a speedup of the process may be attained as compared to the case where the display process is realized by software processing.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The “system” in the present exemplary embodiment is described as a configuration formed by a single device as an example, but may also be a configuration formed by multiple devices.

The exemplary embodiment above describes an example in which the control program is stored in the non-volatile memory 10C. However, the storage location of the control program is not limited to the non-volatile memory 10C. The control program according to an exemplary embodiment of the present disclosure may also be provided by being recorded on a storage medium readable by the computer 10.

For example, the control program may be provided by being recorded onto an optical disc such as a Compact Disc Read-Only Memory (CD-ROM), Digital Versatile Disc Read-Only Memory (DVD-ROM), or Blu-ray Disc. Also, the control program may be provided by being recorded on a portable semiconductor memory such as a Universal Serial Bus (USB) memory or a memory card. The non-volatile memory 10C, CD-ROM, DVD-ROM, Blu-ray Disc, USB, and memory card are examples of a non-transitory storage medium.

Furthermore, the DFE 3 may also download, through the communication unit 11, the control program from an external apparatus connected to the communication channel and store the downloaded control program in the non-volatile memory 10C of the DFE 3. In this case, the CPU 10A of the DFE 3 executes the display process by loading, from the non-volatile memory 10C, the control program that has been downloaded from the external apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A system comprising a processor configured to display, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

(((2)))

The system according to (((1))), wherein the processor is configured to display, on the screen, the description string that is directly embeddable into the print instruction document.

(((3)))

The system according to (((1))) or (((2))), wherein if the specified attribute value is represented by a combination of multiple types of attributes, the processor is configured to display, on the screen, the description string for each of the attributes associated with the specified attribute value.

(((4)))

The system according to any one of (((1))) to (((3))), wherein the print instruction document is described in JDF format.

(((5)))

The system according to any one of (((1))) to (((4))), wherein when any attribute value is specified, the processor is configured to display, on the screen, a selection object for the user to select whether or not to display the description string.

(((6)))

The system according to (((5))), wherein the processor is configured to display, on the screen, the description string for the attribute value that is specified for the first time, even if the selection object had been selected to a setting not to display the description string.

(((7)))

A control program causing a processor to execute a process to display, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

What is claimed is:

1. A system comprising a processor configured to display, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

2. The system according to claim 1, wherein the processor is configured to display, on the screen, the description string that is directly embeddable into the print instruction document.

3. The system according to claim 2, wherein if the specified attribute value is represented by a combination of multiple types of attributes,
the processor is configured to display, on the screen, the description string for each of the attributes associated with the specified attribute value.

4. The system according to claim 1, wherein the print instruction document is described in JDF format.

5. The system according to claim 1, wherein when any attribute value is specified, the processor is configured to display, on the screen, a selection object for the user to select whether or not to display the description string.

6. The system according to claim 2, wherein when any attribute value is specified, the processor is configured to display, on the screen, a selection object for the user to select whether or not to display the description string.

7. The system according to claim 3, wherein when any attribute value is specified, the processor is configured to display, on the screen, a selection object for the user to select whether or not to display the description string.

8. The system according to claim 4, wherein when any attribute value is specified, the processor is configured to display, on the screen, a selection object for the user to select whether or not to display the description string.

9. The system according to claim 5, wherein the processor is configured to display, on the screen, the description string for the attribute value that is specified for the first time, even if the selection object had been selected to a setting not to display the description string.

10. The system according to claim 6, wherein the processor is configured to display, on the screen, the description string for the attribute value that is specified for the first time, even if the selection object had been selected to a setting not to display the description string.

11. The system according to claim 7, wherein the processor is configured to display, on the screen, the description string for the attribute value that is specified for the first time, even if the selection object had been selected to a setting not to display the description string.

12. The system according to claim 8, wherein the processor is configured to display, on the screen, the description string for the attribute value that is specified for the first time, even if the selection object had been selected to a setting not to display the description string.

13. A method comprising:
displaying, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.

14. A non-transitory computer readable medium storing a program causing a computer to execute a process for control, the process comprising:
displaying, when any attribute value that an item defining an operation related to printing may take is specified by a user via a screen, a string corresponding to the specified attribute value on the screen, the string being a description string to be described in a print instruction document with which the user instructs the processor to perform the operation corresponding to the attribute value.
